(19) United States
(12) Patent Application Publication
(10) Pub. No.: US 2025/0146393 A1
(43) Pub. Date: May 8, 2025

(54) EOR DESIGN AND IMPLEMENTATION SYSTEM

(71) Applicant: Schlumberger Technology Corporation, Sugar Land, TX (US)

(72) Inventors: Omer Gurpinar, Denver, CO (US); Jaime Eduardo Moreno Ortiz, Kuala Lumpur (MY); Yun Long Liu, Beijing (CN)

(21) Appl. No.: 18/684,422

(22) PCT Filed: Aug. 18, 2022
(86) PCT No.: PCT/US2022/040707

§ 371 Date: Feb. 16, 2024

Related U.S. Application Data
(60) Provisional application No. 63/260,379, filed on Aug. 18, 2021.

(51) Int. Cl. E21B 43/16; E21B 47/00; G01V 20/00

(52) U.S. Cl. CPC E21B 43/16; E21B 47/00; G01V 20/00; E21B 2200/20

(57) ABSTRACT

A method for implementing enhanced oil recovery includes receiving a model of a subterranean volume of at least a portion of an oilfield and measurements collected for the subterranean volume, determining a model confidence index based at least in part on the model and the measurements, selecting one or more physical parameters for candidate pilot tests based at least in part on the model, the measurements, and the model confidence index, designing pilot tests for the individual candidate pilot tests based at least in part on one or more pilot test objectives, the model, and the model confidence index, selecting one or more pilot tests from among the designed pilot tests, and generating a pilot test implementation plan for the selected one or more pilot tests.

### CROSS-REFERENCE TO RELATED APPLICATION

This application claims the benefit of U.S. Provisional Application No. 63/260,379, entitled “EOR DESIGN AND IMPLEMENTATION SYSTEM,” filed Aug. 18, 2021, the disclosure of which is hereby incorporated herein by reference.

### BACKGROUND

Enhanced oil recovery (EOR) is a class of processes that involve introducing something, e.g., a fluid and/or energy, into a formation that was not present beforehand, and thereby modifying the properties of the oil therein. As a result, when the EOR process is successful, the productivity of the reservoir increases. Various types of EOR processes exist, such as chemical flooding, miscible displacement, and thermal recovery, to name a few.

The EOR process can be quite expensive, however. Moreover, selecting an effective EOR process, field implementation location, and design can be a challenge, and given the expenses, incorrect selections can have heavy consequences. Accordingly, pilot tests are often conducted, generally evaluate the performance of a particular EOR process, location, and design, but on a smaller scale. Even the EOR pilot tests can be expensive, however, and thus it is desirable to perform the testing efficiently.

The design of the EOR pilot tests is complicated, as it includes many different choices from many different types of information, and usually involves teams of subject matter experts from a variety of disciplines making decisions based on incomplete information with potentially high levels of uncertainty, as well as based on personal experience and subjectivity. Utilization of various standalone software products by each member of the multi-domain project team in semi-isolation makes the entire project take too long to complete one non-unique solution. This is often further complicated by inefficient communication among these teams. The result may be uncertainty, inefficiency, and non-repeatability in the EOR pilot test design, which may lead to inefficient pilot testing and potentially even testing and/or field-level failures.

### SUMMARY

Embodiments of the disclosure include a method for implementing enhanced oil recovery includes receiving a model of a subterranean volume of at least a portion of an oilfield and measurements collected for the subterranean volume, determining a model confidence index based at least in part on the model and the measurements, selecting one or more physical parameters for candidate pilot tests based at least in part on the model, the measurements, and the model confidence index, designing pilot tests for the individual candidate pilot tests based at least in part on one or more pilot test objectives, the model, and the model confidence index, selecting one or more pilot tests from among the designed pilot tests, and generating a pilot test implementation plan for the selected one or more pilot tests.

Embodiments of the disclosure include a computing system including one or more processors, and a memory system including one or more non-transitory computer-readable media storing instructions that, when executed by at least one of the one or more processors, cause the computing system to perform operations. The operations include receiving a model of a subterranean volume of at least a portion of an oilfield and measurements collected for the subterranean volume, determining a model confidence index based at least in part on the model and the measurements, selecting one or more physical parameters for candidate pilot tests based at least in part on the model, the measurements, and the model confidence index, designing pilot tests for the individual candidate pilot tests based at least in part on one or more pilot test objectives, the model, and the model confidence index, selecting one or more pilot tests from among the designed pilot tests, generating a pilot test implementation plan for the selected one or more pilot tests.

Embodiments of the disclosure include a non-transitory computer-readable medium storing instructions that, when executed by at least one processor of a computing system, cause the computing system to perform operations. The operations include receiving a model of a subterranean volume of at least a portion of an oilfield and measurements collected for the subterranean volume, determining a model confidence index based at least in part on the model and the measurements, selecting one or more physical parameters for candidate pilot tests based at least in part on the model, the measurements, and the model confidence index, designing pilot tests for the individual candidate pilot tests based at least in part on one or more pilot test objectives, the model, and the model confidence index, selecting one or more pilot tests from among the designed pilot tests, generating a pilot test implementation plan for the selected one or more pilot tests.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for designing and conducting EOR pilot tests and field-level processes, according to an embodiment.

FIG. 3 illustrates a flowchart of a process for evaluating a model of a subterranean volume, e.g., as part of the method of FIG. 2, according to an embodiment.

FIG. 4 illustrates a flowchart of a process for determining historical well performance, e.g., as part of the process of FIG. 3, according to an embodiment.

FIG. 5 illustrates a flowchart of a process for EOR pilot selection, e.g., as part of the method of FIG. 2, according to an embodiment.

FIG. 6 illustrates a flowchart of a process for designing an EOR pilot test, e.g., as part of the method of FIG. 2, according to an embodiment.

FIG. 7 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

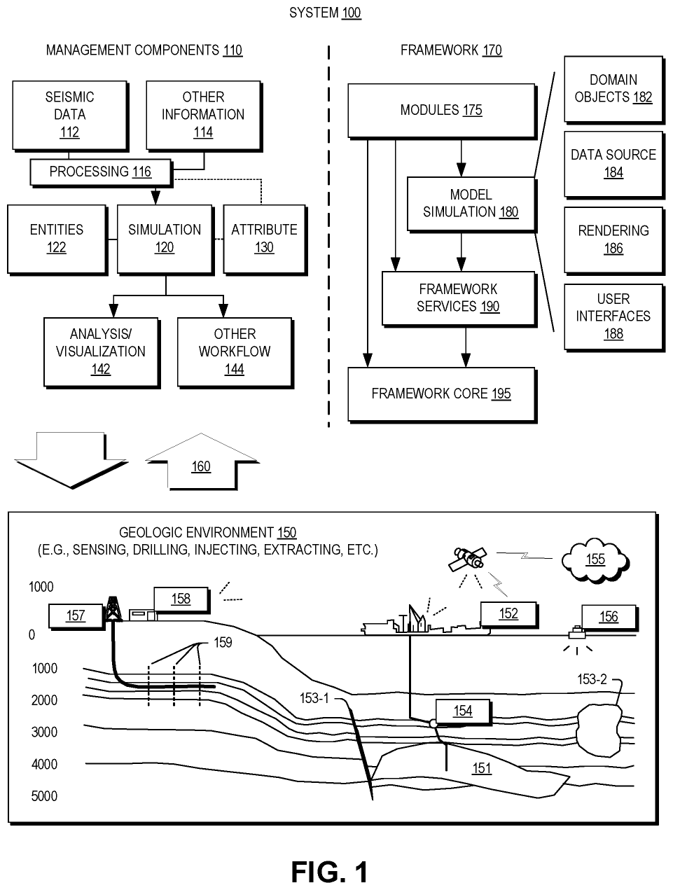

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® NET® framework (Redmond, Washington), which provides a set of extensible object classes. In the NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

In general, embodiments of the present disclosure include systems and methods for designing and implementing enhanced oil recovery (EOR) processes in an oilfield. EOR refers to any process in which a material, generally a combination of fluids and/or gases, is injected into a formation for the purposes of increasing the production of an objective fluid (e.g., hydrocarbon) from the formation. Such EOR processes may increase the recovery of the objective fluid from the well by increasing pressure, reducing viscosity, or otherwise making the reservoir more conducive to targeted fluid migration and extraction. There are many different types of EOR processes, including gas injection (e.g., CO2 gas), steam flooding, water flooding, polymer flooding, microbial injection, liquid carbon dioxide injection, water-alternating-gas, etc. Any of these processes and/or others may be employed. In these processes, fluid is injected into a subterranean formation via an injector well. The injected fluid promotes the migration of the objective fluid through the formation to one or more producer wells, via which the objective fluid is recovered, potentially along with at least some of the injected fluid.

A given EOR project may call for the drilling, completion, and/or workover of several wells, and thus can be an expensive endeavor. Accordingly, pilot tests may be done in order to decrease uncertainty as to economic value of an EOR endeavor. Embodiments of the present method may be employed to more precisely, accurately, and efficiently design pilot tests. The design of the pilot tests may be configured to result in the achievement of certain enumerated (e.g., prior to conducting the test) objectives, such as various formation or fluid parameters, recovery rates, etc., the achievement (or failure) of which may impact the economic value of the pilot test. Embodiments of the present disclosure may evaluate many different candidate pilot test possibilities, and provide an automatic selection of one or more candidates based on the economic value thereof, and may in turn result in more economically efficient design of field-level EOR processes.

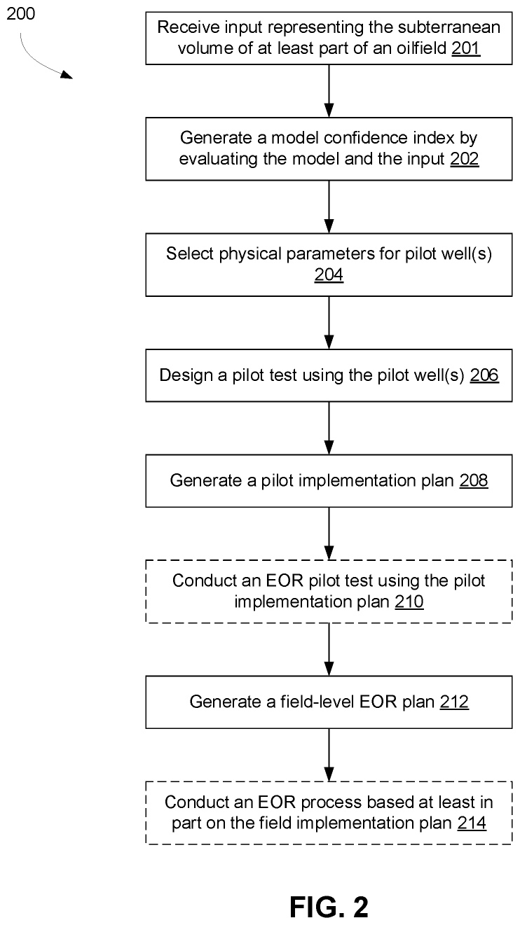

FIG. 2 illustrates a flowchart of a method 200 for design and implementation enhanced oil recovery (EOR) processes, according to an embodiment. More particularly, for example, the method 200 may be configured for designing pilot tests for such EOR processes. It will be appreciated that the method 200, as well as any other methods, processes, and/or workflows presented herein, may be carried out in the order shown, or in any other order. Moreover, various aspects of such methods, processes, and workflows may be combined or separated, conducted in parallel, simultaneously, or in sequence.

The method 200 may include receiving input, as at 201, representing a subterranean volume (and potentially a surface) of at least a part of an oilfield. The input may include, for example, one or more digital models of the subterranean volume. For example, a three-dimensional model of the subterranean domain may be generated and/or received as input. A variety of different types of models may be available and may be employed consistent with the method 200. For example, reservoir models, rock property models, fluid flow models, basin models, facies models, etc. may be employed. The models may be constructed based in part on data acquired from various sources, such as seismic, well logs, core samples, etc. Among other things, such models may be employed to forecast the formation response to different EOR processes, e.g., to determine what type of EOR processes may be employed and identify efficient locations and parameters for injection and/or production wells. Historical production data may also be provided, which may include the fluid properties of the reservoir fluid.

The models may have uncertainty associated therewith, including uncertainty from the data acquisition, uncertainty in extrapolation to areas between wells or other data collection locations, uncertainty from upscaling certain areas (e.g., near the well), and potentially other sources. Accordingly, the method 200 may include evaluating the uncertainty in the model, e.g., by generating a model confidence index as at 202. In a specific example, the model confidence index may be provided in the form of a map that represents varying values for the model confidence at different discrete areas of the model. The model confidence index (or, inversely the level of uncertainty distribution in the model) may be quantified at least partially based on the historical production data, robustness of available data for a given area, and/or the like. For example, history matching may be employed, in which expected production measurements may be calculated using the model, e.g., by simulating production in the model. These expected production measurements may be compared to actual historical production data, and the expected may be compared to the measured, in order to determine how well the model represents the subterranean volume and, e.g., fluid flow therein. Various techniques may be employed to adapt the model for history matching, and the use of such adjustments may also be tracked and may impact the model confidence index for the specific locations in the model, as will be described in greater detail below.

The method 200 may also include selecting one or more physical parameters for pilot test well(s) (e.g., groups of wells for implementing a pilot test) based at least in part on the model and the model confidence index, as at 204. The identification of physical parameters for pilot test wells may include, for example, a location of the wells, e.g., based on reservoir properties and the distribution thereof. The physical parameters may also include, for example, a number or “count” of wells, a size, shape, location of the individual wells, etc. The count, size, shape, and location of the wells may be a function of formation properties, fluid flow properties, etc., and thus are selected at least partially based on the model(s). If reservoir property distribution is consistent across the reservoir, a single are (or potentially a few areas) may be representative of the reservoir; otherwise, additional pilot areas may be selected to represent reservoir properties in each major section of the reservoir property distribution. Once location and count of pilot area are selected, the method 200 may identify the minimal pilot size and what pattern may be used (single well or multiple wells) for individual pilots that may reduce the piloting period.

Further, the model confidence index may identify areas where there is insufficient data or too high uncertainty for a pilot test to be implemented within a predetermined or otherwise acceptable risk tolerance. In such case, the model confidence map may be used by operators as guidance for where and what types of measurements may be collected to efficiently enhance model confidence.

Artificial intelligence (AI), including machine learning models trained using historical EOR pilot test and implementation data, may be employed to identify patterns in the parameters and select pilot test wells and/or physical parameters thereof. The AI may select the pilot test wells/parameters based at least partially on the identified patterns, as will be described in greater detail below. Thus, the method 200 may bring to bear historical knowledge gleaned from past EOR implementations into the decision-making process for selecting new pilot test wells/parameters.

The method 200 may include designing pilot tests for the candidate pilot test wells based at least in part on the model, one or more pilot test objectives, and/or the selected physical parameters, etc. as at 206. For areas where the model confidence index is determined to be acceptable, the method 200 may select one or more EOR pilot test types at least partially by comparing formation properties and fluid movement/containment properties to a library of EOR parameters. For example, certain EOR processes may be more efficient and/or effective for certain types of formation or structures. In addition, the model of how the fluid moves in the formation may be beneficial for identifying efficient and effective locations, geometries, orientations, etc. for the pilot wells. Further, the type of measurements to record, location for the measurements, and frequency of measurements may be determined, e.g., based in part on the model, EOR pilot objectives, EOR objectives, uncertainty, etc. Artificial intelligence may be employed to identify patterns in the parameters and select EOR processes based at least in part thereon, thus bringing to bear historical knowledge gleaned from past EOR implementations.

The pilot test objectives may be predetermined or received as input, e.g., from an EOR agent. Pilot test objectives may include, for example, confirming recovery process achieved incremental recovery, achieving injectivity target, ensuring containment and conformance, development of an oil bank, monitoring EOR agent integrity, monitoring EOR agent utilization, development of a monitoring plan, assessing development options on recover (e.g., well spacing). The pilot test objectives can also include more specific items, such as reservoir salinity, injection rate, injection fluid viscosity, solution concentrations (e.g., polymer, CO2, etc.), oil saturation, incremental recovery (e.g., compared to a baseline of no EOR or another type of EOR), understanding of possible chromatographic separation, impacts on emulsion, scaling, and corrosion, impact on artificial lift, mobility ratio/slug size, and/or sand production. It will be appreciated that this list is intended to provide examples and is not exhaustive. Further, the pilot test design may specify what parameters are to be measured, and a measurement frequency, which may enhance economic efficiency of the pilot test.

The test pilots that were designed may then be evaluated. The candidate test pilots may be evaluated according to an economic factor, such as net present value. Various techniques for such evaluation may be employed, such as calculating an objective function that yields the net present value according to variables, which may then be adjusted to increase the objective function. Such objective function may consider the extent to which the pilot test objectives are satisfied, as such satisfaction may not be binary, but rather a scale.

Further, AI, e.g., including machine learning models/algorithms trained using historical EOR pilot test and implementation data, may be employed to identify patterns in the data and design the EOR pilot test accordingly, as will be described in greater detail below. Thus, the method 200 may bring to bear historical knowledge gleaned from past EOR implementations into the decision-making process for designing the pilot test.

A pilot test implementation plan may then be generated, as at 208, by selecting one or more of the candidate pilot tests. The candidate pilot tests may, for example, be ranked and one or more of the higher value (or any other factor) pilot tests may be selected for implementation. The plan may include the design details, such as the pilot well count, location, size, geometry, and EOR parameters such as fluid concentration, salinity, etc. The test pilot implementation plan may include the selected physical parameters for the pilot test (e.g., location, count, size, etc.), and the type of EOR selected, as well as a monitoring plan. The monitoring plan may include what measurements are to be taken, where they are to be taken, the frequency with which they may be taken, or a combination thereof. Measurements not included in the monitoring plan may also be taken, but may represent measurements that may be less effective or efficient to take beyond those specified in the monitoring plan, as taking additional measurements incurs additional costs.

The pilot test may, in some cases, then be implemented and evaluated, as at 210. Once evaluated, an operator may determine whether to implement the EOR based partially on the pilot test results, e.g., according to a risk tolerance determination. If an EOR is selected, the method 200 may include generating a field level implementation according to the selected EOR, as at 212. The selected EOR may then be implemented using the field implementation plan, as at 214. This may include drilling one or more injection and/or production wells, reconfiguring one or more existing wells, etc.

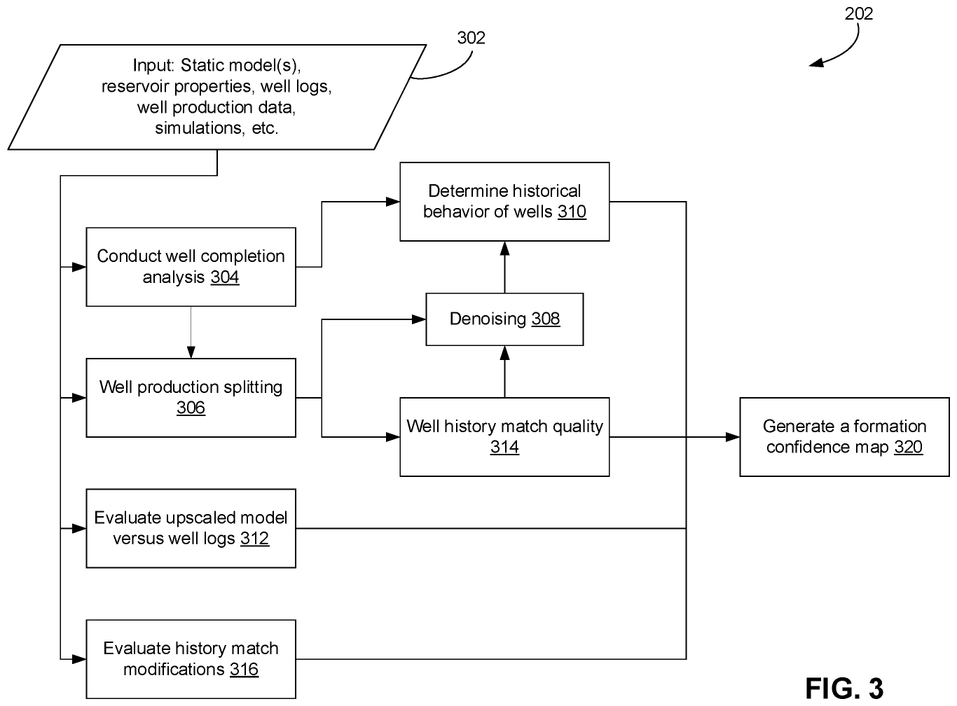

FIG. 3 illustrates a more detailed flowchart of block 202 from FIG. 2, i.e., a process for generating a model confidence map (e.g., including the model confidence index discussed above), according to an embodiment. In general, the block 202 may be configured to classify confidence levels for a given formation using the production history and modeling. The block 202 may thus be applied in a variety of contexts in which a model is employed, e.g., well infilling location identification, well workover advising, production performance enhancement, etc.

In the illustrated example, the block 202 may begin by receiving various inputs representing the subterranean volume, as at 302, which will be described in greater detail below. For example, at least one of the inputs may include a model of the subterranean domain (e.g., static model, dynamic model, etc.), which may quantify and permit (and/or reflect) simulation of various reservoir properties. At least a portion of the model may be upscaled, e.g., near existing wells. The reservoir properties represented by the upscaled portion of the model may thus be compared to any available well logs to determine well point upscaling quality, which may be a factor for the model confidence index.

The block 202 may include conducting a well completion analysis, e.g., to index the wells that are presently available in a field, as at 304. The well completion analysis may include receiving, as part of the input at 302, formation description (e.g., formation name versus Karnaugh map (K-map)). The input may also include well completions information and fluid saturation historical measurements. The well completion analysis may then include cross-checking well completion history and connecting a status to the formations. The well completion analysis may also generate well-to-formation mapping along the production history. The well completion analysis may also identify well types (e.g., injector, producer, horizontal, or vertical), identify well status (open/shut), and identify completion type (plugback/squeeze). The well completion analysis may thus provide well-to-formation mapping and well completion type indexing as output, which may be used in other processes as part of the method 200, as will be noted below.

The block 202 may further include splitting well production as a portion of cumulative flow capacity (KH), as at 306. This may include taking as input reservoir properties such as permeability (K) and formation thickness (H), simulated well production results, and raw production history. Further, this process may employ the well-to-formation mapping established as part of the well completion analysis conducted at 304. The well production splitting process 306 may then include calculating total cumulative flow capacity (e.g., permeability times thickness of the production interval), and calculating the KH proportion of the total KH for individual formations. The well production data for an individual formation may then be calculated as total production multiplied by the KH proportion for the formation. The outputs may then be well production from the formation, both simulated and measured/raw.

The block 202 may also include performing a denoising process, as at 308. The denoising process may receive the well production data from the formation, e.g., the raw well production data output by the well production splitting process at 306. For example, a pattern recognition algorithm may be employed to identify outlier or otherwise likely spurious datapoints in the production measurements, which may be caused by acquisition noise. Thus, the pattern recognition algorithm may be trained to recognize trends in the production data and then remove data points that are larger than a predetermined error to the mean value of the trend at a point. The output is denoised (i.e., reduced noise) measured well production data. As the term is used herein, “pattern recognition algorithm” refers to any type of AI, e.g., a machine-learning model, which evaluates and classifies a dataset. For example, a machine-learning model may be trained to perform such evaluations/classifications, e.g., in a supervised learning environment, in which labeled datasets, e.g., from historical reservoir data, are provided. The machine learning model may thus permit for efficient comparisons of data, e.g., without performing complex statistical comparisons, but rather (or additionally) through comparing patterns in different datasets.

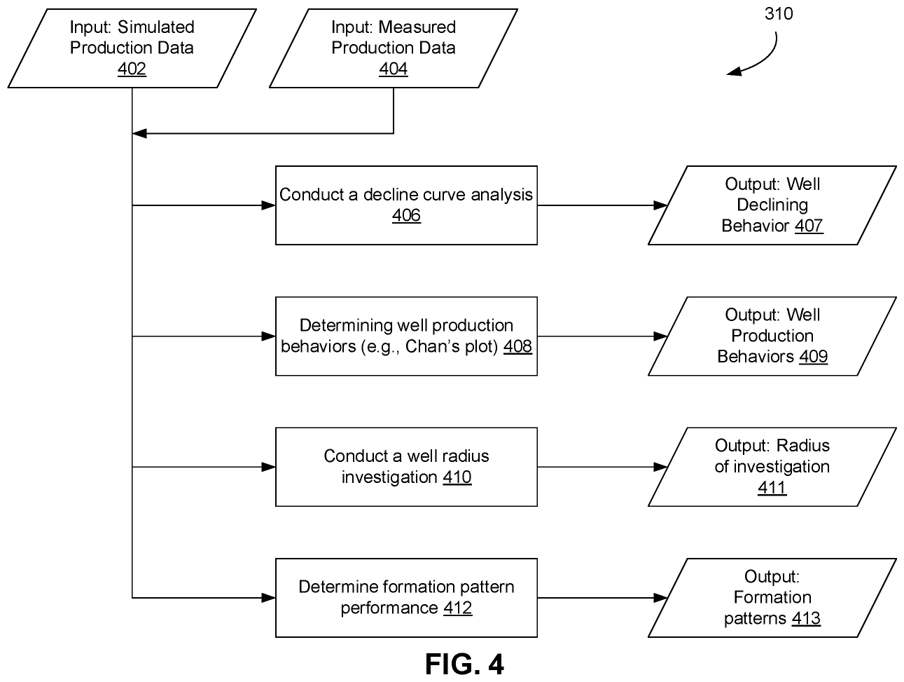

The block 202 may then proceed to determining historical behavior of the wells, e.g., channeling, coning, etc.), as at 310. This block 310 is illustrated in greater detail in FIG. 4. Referring to FIG. 4, the production data, both simulated and measured (e.g., reduced noise) may be received as inputs 402, 404. The block 310 may then include conducting a decline curve analysis, as at 406. Conducting a decline curve analysis may include building well oil production rate (or liquid rate) versus time/date relationship, e.g., in a semi-log scale. A pattern recognition algorithm may be trained to recognize a pattern in the (e.g., noise reduced) well production data within a selected period of time. An equation that fits the trend may then be generated, yielding production coefficients for the individual wells. The pattern recognition algorithm may avoid intensive calculation procedures for recognizing trends, as this may be conducted on a well-by-well basis, potentially for several different types of parameters. As an output at 407, well declining behavior may be provided, e.g., including average production rate per formation and date range. A well production declination rate may also be provided.

The block 310 may then include determining well production behaviors (e.g., using a Chan's plot), as at 408. In block 408, the simulated and measured well production data received as inputs 402, 404 may again be employed. The block 408 may include calculating a well water-oil ratio and a water-oil ratio derivative for the simulated data and the measured production data. The water-oil ratio and water-oil ratio derivative may then be plotted as a function of time (production days) in a log-log plot.

A pattern recognition algorithm may be trained to recognize trends in both plots. The pattern recognition algorithm may also be trained to select a type of Chan's plot that fits a recognized trend. This may facilitate identifying behaviors such as water channeling, coning, etc. in the well production behavior. The results may be compared to determine consistency between the trends identified in the simulated and measured production data. As a result, at 409, the block 310 may produce well production behaviors for the wells (well points), as well as well point water status, well point gas status, and result consistency between the measured and simulated production data.

The block 310 may also include conducting a well radius investigation, as at 410. The block 310 may include accessing inputs 402, 404, as well as reservoir properties (e.g., permeability, thickness, porosity), model simulation results (e.g., Bo, Sw, Sor). The block 310 may then calculate a radius of investigation as output at 411, which may vary depending, for example, on whether the reservoir is under hydraulic control or volumetric control. For example, hydraulic control may be the case if there is no apparent decline in the reservoir pressure because of water influx and/or water drive, and volumetric control may be the case if there is no water influx to replace the displaced oil and the oil is replaced by gas.

The block 310 may also include determining formation pattern performance, as at 412. The block 412 may include accessing the well completions data, as well as the (e.g., denoised) measured well production data. The block 412 may also include recognizing current well pattern(s) in the formation related to areal completion layout. The patterns may be indexed, e.g., given a unique identifier. Total injection fraction to hydrocarbon pore volume (HCPV) versus total production fraction to HCPV may then be calculated. Identify good patterns and poor patterns in the formation. The formation patterns, including decision as to quality, may be provided as output at 413.

Returning to FIG. 3, the block 202 may further include comparing the upscaled model to available log data, both received as input at 302, in order to permit a determination as to quality of the upscaling done in the model, as at 312. The block 312 may also include receiving reservoir properties and well logs. The pore volume difference may then be compared between a fine grid (relatively high resolution) and a coarse grid (relatively low resolution) of the model. A determination as to quality may be made for the individual cells or groups of cells (or other discrete elements) of the model. In a specific embodiment, a difference of less than 3% may be considered high quality and given a value (e.g., one). A difference of more than 5% may be considered low quality and given a value (e.g., three). A value between those two thresholds may be considered fair quality and given a value (e.g., two). Similarly, the variable density profile in the well log may be compared for fine grid and coarse grid cells and given a quality value, e.g., one if the difference is less than 10%, two if the difference is between 10% and 20%, and three if the difference is greater than 20%. It will be appreciated that the foregoing numbering and thresholds are merely examples and others may be implemented. The quality values may then be provided as outputs.

The block 202 may also include determining a well history match quality, as at 314. The block 314 may receive, as input, the well production data from the formation (e.g., denoised at 208), as well as simulated well production data, and the well-to-formation mapping (generated at 204). The block 314 may check a curve match quality (e.g., root mean square (RMS) calculation of mismatching), and trend match quality (e.g., pressure profile, water profile, gas profile). A pattern recognition algorithm may be employed to recognize and quantify the history match quality. Thus, parameter trend matching may be integrated into the history match process, which may increase an efficiency of arriving at a comprehensive history matching. Well point mismatching (e.g., per well) may be provided as output from the block 314.

The block 202 may also include evaluating history match modifications, as at 316. Block 316 may include receiving reservoir properties before history-match modifications have been applied thereto, e.g., at any time in history and at an end of the history (according to the analysis). For example, the model at the history endpoint may be compared, before and after history matching. Similarly, the model at any other point may be compared, before and after history matching. The individual properties represented by the individual cells may then be compared both before and after history matching to determine a change in the properties. For example, the property after history matching may be divided by the property before history matching. If the ratio is one, no modification mis present. If the property value is greater than one, the property value increased in the history matching. If the value is less than one, the property value decreased during history matching.

Based on at least some of the outputs described with reference to blocks 304-316, the block 202 may generate a confidence map for the model, as at 320. For example, the block 320 may include initially setting areas without a well to a medium or “fair” confidence level. For example, the values for the qualities discussed above may be added together, or otherwise combined, permitting a direct scoring of the well confidence. The well point confidence may be overlayed with a general property modification map to yield a formation or “model” confidence map. The confidence level may then be adjusted according to well confidence level and drainage radius calculated

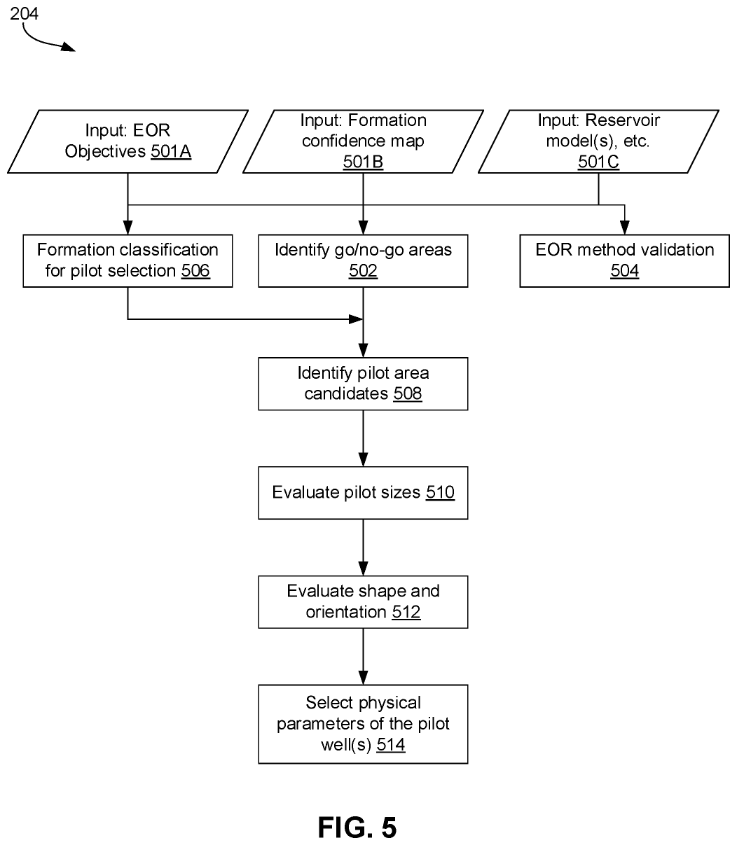

As discussed above with respect to FIG. 2, the model confidence index (e.g., formation confidence map) may be employed in identifying and evaluating candidate pilot tests for enhanced oil recovery at 204. FIG. 5 illustrates a more detailed view of the block 204, showing a process for such selection of pilot tests, according to an embodiment. The block 204 may produce a count, location, size, shape, orientation, or other physical properties of wells for the pilot test, e.g., using understanding gleaned from the well production history and other reservoir determinations.

The block 204 may receive several different inputs, including outputs from previous blocks discussed herein and elsewhere. For example, the block 204 may receive EOR objectives, as will be described below, as at 501A. The block 204 may also receive the formation confidence map, as generated above, as at 501B. The block 204 may further receive other input, such as reservoir models, simulation results, surface constraints, or anything else that describes the surface or the subsurface, as at 501C.

The block 204 may include determining a go/no-go area in the formation, as at 502. Various property maps may be overlayed to determine these areas. For example, formation permeability difference maps may be employed, where cells representing the bottom layer permeability being less than the top layer of the bottom formation being of lower value than those where the bottom layer permeability is greater than the top layer of the bottom formation. Similarly, an aquifer location map at the end of the history may be analyzed, e.g., to determine aquifer invasion. Gas cap location may also be determined, along with areal containment and surface constraints, e.g., individually as separate maps that may be combined. A weight may be assigned to each of the maps. The weights may be equal, or may be modified depending, e.g., on the reservoir. The maps may be overlayed, so as to indicate go/no-go (and/or may go) areas from the combination of the maps, where each individual map may be capable of producing a no-go area in the final map, e.g., if the individual, underlying map indicates that a particular area represents a high risk for pilot testing.

Different enhanced oil recovery methods may then be validated for the model, as at 504. For example, formation groupings may be received as input, with the property being non-reservoir, low quality, or high quality, for example. LHI may then be calculated as the negative of log (sand body mean length) over inter-well distance. VHI may be calculated as the negative of log (sand body mean thickness) over gross reservoir thickness. LHI and VHI values may be projected into a heterogeneity index matrix and labeled as high, medium, or low, e.g., based on static or dynamic thresholds. An EOR matrix may also be received, which may include locations representing the applicability of different EOR methods in different formations. The feasibility of the different EOR methods may then be determined. A machine learning model may be used to verify EOR methods. For example, existing EOR project data may be used to train the machine learning model.

The block 204 may also include formation classification for pilot selection and pilot candidates, as at 506. For example, maps for formation KH, and go/no-go areas may be received as input. EOR pilot objectives may also be received as input. Accordingly, the formation KH may be initially employed to create classifications of areas, which may be combined with the go/no-go map to determine pilot candidates per area.

Further, a heterogeneity map may be employed to determine a candidates per area map, e.g., at a relatively large area size without changing heterogeneity. Formation property maps such as vertical and horizontal permeability, remaining oil, and formation confidence may then be employed. For example, small candidates may be evaluated to determine which have a heterogeneity distribution consistent with the area where the candidate is located. The candidates may be ranked using the confidence map, permeability ratio (vertical over horizontal), and remaining oil. Higher ranked candidates may be located in areas with relatively high confidence, lower permeability ratio, and higher remaining oil. The top ranked candidates (e.g., any predetermined or user-defined number) may then be selected as pilot candidates. In at least some embodiments, pattern recognition (e.g., machine learning models) may be employed to identify the potential pilot areas with reservoir property distribution consistent to a particular area. The output may be a pilot candidates per area map.

The block 204 may then proceed to identifying pilot area candidates, as at 508. For example, the block 508 may receive the candidates per area map, along with EOR pilot objectives, and EOR specific grid size. The candidate area map may then be regridded to the resolution of the EOR specific grid size. A water flooding simulation (e.g., five spot) may be run to test containment for each candidate, and the candidates may be ranked according to containment for each area. Multiple simulations may be run concurrently, e.g., utilizing remote computing resources, so as to increase the speed at which multiple candidate pilots may be tested. The result map be a candidate per area map, e.g., with fewer (e.g., the top ranked) candidates identified.

The block 204 may then proceed to evaluating pilot sizes (e.g., number of wells, area size, etc.), as at 510. The pilot candidate per area map (e.g., winnowed down to the top-ranked candidates in the block 508) may be provided, along with EOR pilot objectives, EOR agent properties, and the well declining behavior. The block 510 may include for the individual pilot candidates in each area, define a plurality (e.g., three) reservoir simulation models (e.g., five-spot) using a resolution specific to EOR grid size. EOR method simulations may then be run for the individual model sizes, and the injection traced from different injectors. Production rate may reuse historical averages in the area. A flow behavior plot of volume of injectant contact versus breakthrough time may be created for the individual candidates, e.g., for the individual model sizes (e.g., small, medium, and large). The plots for the different model sizes may be provided in the same plot. Pattern recognition (e.g., trained machine learning model) may then be used to select a plot size for each candidate among the pre-trained combinations, e.g., a minimal pilot size. In this process, multiple simulations may be run in parallel, e.g., using remote computing resources. As a result, the block 310 may provide specific pilot locations within the candidates per area map.

The block 202 may also include evaluating pilot shape and orientation, as at 512. The block 512 may receive the pilot location and size per area map, as modified at 510. The block 512 may also receive a field background flow direction, e.g., determined using a model of the subterranean domain. EOR pilot objectives may also be received. The EOR simulation model may be setup as per injection pattern, e.g., providing the injectors at the “upwind” side. The patterns may be ranked using the simulation results, e.g., based on high injection conformance and flow efficiency. Again, multiple simulations may be run concurrently, and additional (e.g., remote) computing resources may be employed for parallel processing. The output at 514 may be a pilot simulation case for the areas with orientation and selected pattern.

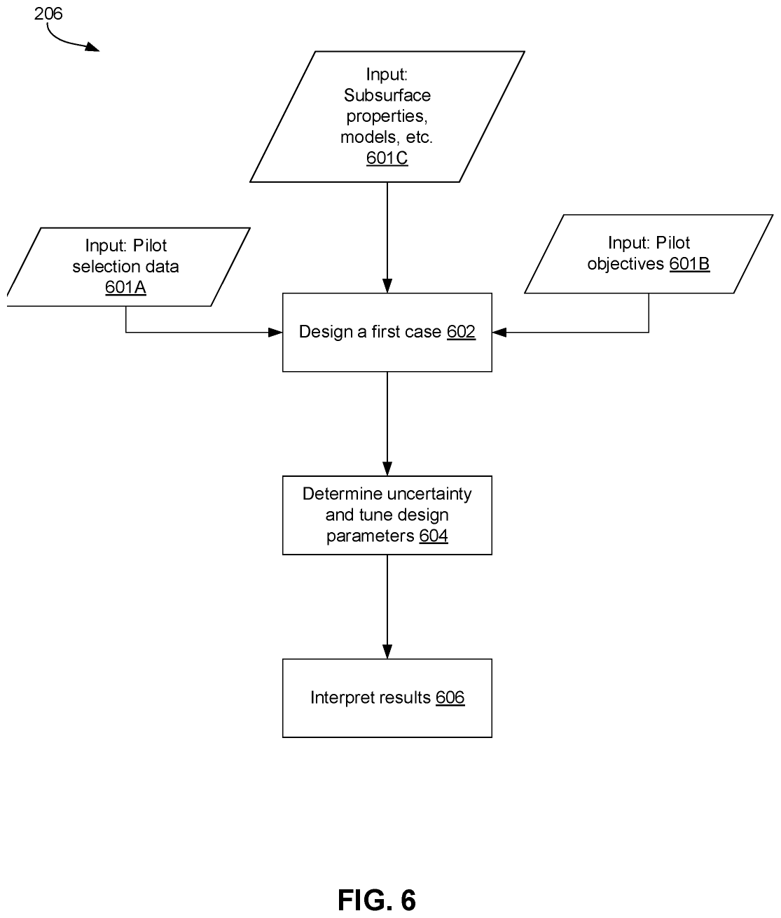

As noted above, pilot design may be conducted after pilot selection. FIG. 6 illustrates the pilot design and selection block 206 of FIG. 2, but in greater detail, according to an embodiment. The block 206 may include a first case design, as at 602. Input for this block 602 may include the pilot selection data (e.g., as generated in block 204) as at 601A, the pilot objectives (and/or the EOR objectives, agent parameters, etc.), as at 601B, and any other data representing the formation (e.g., models, etc.), as at 601C. For example, the input may include pilot objectives, EOR agent properties, the pilot simulation case for areas with orientation and selected pattern (e.g., the output from the pilot selection block 204). The pilot objectives may include expected piloting period, expected recovery process at pore level, expected conformance, expected containment, agent utilization, economic efficiency, monitoring objectives, any subset or combination thereof, etc. The block 602 may first determine whether a pilot is located at an existing producer well. If it is, the well completion type may be received in order to account for reusing the existing completion(s). If not, new completions may be employed, and a permeability-thickness map may be received to determine KH weighted production.

The block 602 may then define a no-further-action caser at the pilot area and use a KH weighted production rate to produce the pilot. This may be a baseline for subsequent comparison. The block 602 may then define an EOR pilot case by reusing the production rate of the no-further-action case with corresponding injection rates. The EOR agent usage in the pilot area may be determined using formula, injection rate, slug combination and size, piloting period and/or other factors. The economic efficiency may also be defined (e.g., net present value). A present monitoring site in the pilot model may also be selected and a calculation of measurable rate may be determined for monitoring measurements. The EOR pilot case may then be adjusted based on economic efficiency, e.g., using an objective function that considers variables and associated coefficients for injection and production rates, EOR formula, slug sizes, etc. The output may be the production from the no-further-action case, an identification of the EOR pilot designs that satisfy one or more EOR pilot objectives, and the EOR pilot cases as adjusted to enhance economic efficiency.

The block 206 may also include determining uncertainty and tuning design parameters, as at 604. Block 604 may receive EOR pilot objectives, EOR-specific uncertainties, reservoir uncertainties, and the EOR pilot case (output from block 602). The EOR pilot objectives may be expressed as one or more objective functions. Accordingly, block 604 may include analyzing the EOR pilot case sensitivity to the uncertainties and ranking the sensitivities or identifying those that are object a certain threshold (e.g., “major” uncertainties). A probability map may then be built for the EOR pilot for the individual pilot objectives. Simulations and probability maps may be run/constructed in parallel using remote computing resources, e.g., using a machine learning algorithm. Further, the simulations may be used as input to train subsequent machine learning processes.

The block 206 may also include interpreting results, as at 606. For example, the probability maps generated for the monitoring measurements may be received, along with the EOR pilot candidates that fulfill one or more of the EOR pilot objectives. The probability maps and EOR pilot candidates that are identified may then be used to produce a monitoring and control plan, which may identify what type of measurements (e.g., what parameters) to measure, where to measure the parameters, and when and with what frequency to take the measurements. Operational ranges and strategies may also be developed.

Block 606 may also include predicting the chances of pilot success. For example, the EOR pilot candidates that fulfil one or more EOR pilot objectives from the uncertainty analysis may be combined with a probability of the individual EOR pilot objectives, which may yield the chances of pilot success. The pilots may be ranked at least partially according to the chances of success, and the sources of risk of failure may also be indexed therewith (e.g., reservoir issues, well issues, facilities issues, etc.).

As new EOR pilot test plans are selected, designed, and/or planned, the machine-learning models may be trained and retrained to account for the results of the EOR pilot tests. Thus, the machine-learning algorithms may be used to find high probability areas for monitoring and controlling under certain operational conditions.

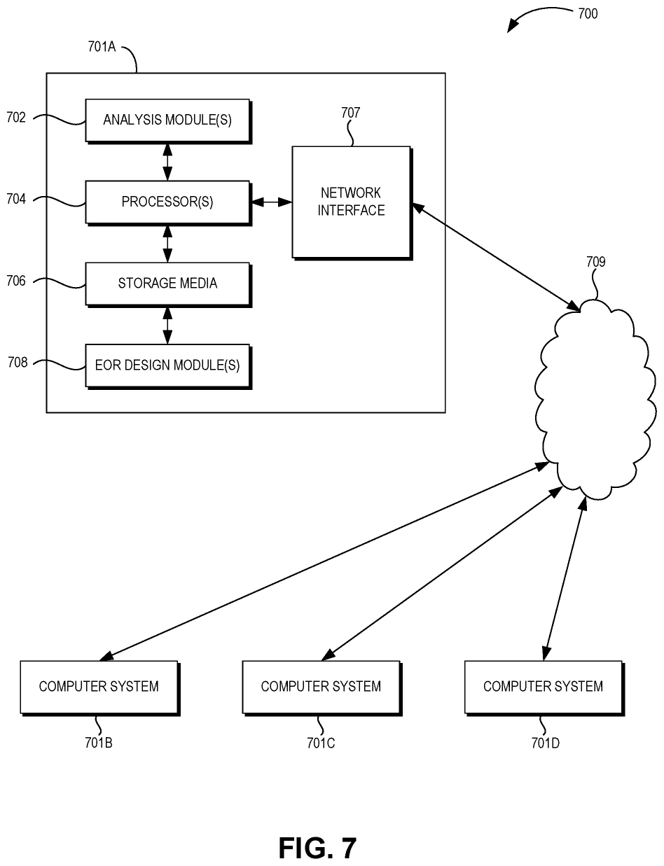

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more EOR design module(s) 708. In the example of computing system 700, computer system 701A includes the EOR design module 708. In some embodiments, a single EOR design module may be used to perform some aspects of one or more embodiments of the methods disclosed herein. In other embodiments, a plurality of EOR design modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for implementing enhanced oil recovery, comprising:
receiving a model of a subterranean volume of at least a portion of an oilfield and measurements collected for the subterranean volume;
determining a model confidence index based at least in part on the model and the measurements;
selecting one or more physical parameters for candidate pilot tests based at least in part on the model, the measurements, and the model confidence index;
designing pilot tests for the individual candidate pilot tests based at least in part on one or more pilot test objectives, the model, and the model confidence index;
selecting one or more pilot tests from among the designed pilot tests; and
generating a pilot test implementation plan for the selected one or more pilot tests.

2. The method of claim 1, wherein determining the model confidence index comprises:
conducting a well completion analysis;
splitting well production as a portion of cumulative flow capacity;
evaluating an upscaled model versus well logs; and
evaluating history match modification in the model.

3. The method of claim 2, wherein determining the model confidence index further comprises:
denoising well production data received as input;
determining a well history match quality; and
determining a historical behavior of one or more wells in the oilfield based at least in part on the well completion analysis, the denoised well production data, and the well history match quality.

4. The method of claim 3, wherein determining the model confidence index further comprises generating a formation confidence map based at least in part on the historical behavior of the one or more wells, the well history match quality, the upscaled model versus well logs, and the history match modifications.

5. The method of claim 3, wherein determining the historical behavior of the one or more wells comprises:
conducting a decline curve analysis using a machine learning algorithm;
determining one or more well production behavior trends using a machine learning algorithm;
conducting a well radius investigation; and
determining a formation pattern performance.

6. The method of claim 1, wherein selecting one or more physical parameters for candidate pilot tests comprises:
validating or more EOR methods for use based at least in part on the model and one or more EOR objectives;
identifying one or more go/no go areas based on one or more surface constraints, one or more EOR objectives, and the model; and
classifying one or more formations in the subterranean volume for pilot selection.

7. The method of claim 6, wherein selecting the one or more physical parameters for candidate pilot tests further comprises:
identifying pilot area candidates;
evaluating pilot sizes;
evaluating shape and orientation of one or more wells for inclusion in the candidate pilot tests;
selecting the one or more physical parameters of the pilot wells based at least in part on the identified pilot area candidates, the evaluated pilot sizes, and the evaluated shape and orientation.

8. The method of claim 1, wherein designing the pilot tests comprises:
designing a first case;
comparing the first case to a base case of no EOR activity;
determining an uncertainty in the design of the first case;
adjusting one or more design parameters of the first case; and
interpreting results of the adjusting.

9. The method of claim 8, wherein interpreting the results comprises predicting a chance of pilot success.

10. The method of claim 8, wherein designing the first case comprises reusing a production rate of the base case with a corresponding injection rate.

11. The method of claim 1, wherein the pilot test implementation plan includes a monitoring plan that includes parameters to be measured, frequency for taking measurements, location for taking measurements, or a combination thereof.

12. A computing system, comprising:
one or more processors; and
a memory system including one or more non-transitory computer-readable media storing instructions that, when executed by at least one of the one or more processors, cause the computing system to perform operations, the operations comprising:
receiving a model of a subterranean volume of at least a portion of an oilfield and measurements collected for the subterranean volume;
determining a model confidence index based at least in part on the model and the measurements;
selecting one or more physical parameters for candidate pilot tests based at least in part on the model, the measurements, and the model confidence index;
designing pilot tests for the individual candidate pilot tests based at least in part on one or more pilot test objectives, the model, and the model confidence index;
selecting one or more pilot tests from among the designed pilot tests; and
generating a pilot test implementation plan for the selected one or more pilot tests.

13. The computing system of claim 12, wherein determining the model confidence index comprises:
conducting a well completion analysis;
splitting well production as a portion of cumulative flow capacity;
evaluating an upscaled model versus well logs; and
evaluating history match modification in the model.

14. The computing system of claim 13, wherein determining the model confidence index further comprises:
denoising well production data received as input;
determining a well history match quality; and
determining a historical behavior of one or more wells in the oilfield based at least in part on the well completion analysis, the denoised well production data, and the well history match quality.

15. The computing system of claim 14, wherein determining the model confidence index further comprises generating a formation confidence map based at least in part on the historical behavior of the one or more wells, the well history match quality, the upscaled model versus well logs, and the history match modifications.

16. The computing system of claim 14, wherein determining the historical behavior of the one or more wells comprises:
conducting a decline curve analysis using a machine learning algorithm;
determining one or more well production behavior trends using a machine learning algorithm;
conducting a well radius investigation; and
determining a formation pattern performance.

17. The computing system of claim 12, wherein selecting one or more physical parameters for candidate pilot tests comprises:
validating or more EOR methods for use based at least in part on the model and one or more EOR objectives;
identifying one or more go/no go areas based on one or more surface constraints, one or more EOR objectives, and the model; and
classifying one or more formations in the subterranean volume for pilot selection.

18. The computing system of claim 17, wherein selecting the one or more physical parameters for candidate pilot tests further comprises:
identifying pilot area candidates;
evaluating pilot sizes;
evaluating shape and orientation of one or more wells for inclusion in the candidate pilot tests;
selecting the one or more physical parameters of the pilot wells based at least in part on the identified pilot area candidates, the evaluated pilot sizes, and the evaluated shape and orientation.

19. The computing system of claim 12, wherein designing the pilot tests comprises:
designing a first case;
comparing the first case to a base case of no EOR activity;
determining an uncertainty in the design of the first case;
adjusting one or more design parameters of the first case; and
interpreting results of the adjusting.

20. The computing system of claim 19, wherein interpreting the results comprises predicting a chance of pilot success.

21. The computing system of claim 19, wherein designing the first case comprises reusing a production rate of the base case with a corresponding injection rate.

22. The computing system of claim 12, wherein the pilot test implementation plan includes a monitoring plan that includes parameters to be measured, frequency for taking measurements, location for taking measurements, or a combination thereof.

23. A non-transitory computer-readable medium storing instructions that, when executed by at least one processor of a computing system, cause the computing system to perform operations, the operations comprising:
receiving a model of a subterranean volume of at least a portion of an oilfield and measurements collected for the subterranean volume;
determining a model confidence index based at least in part on the model and the measurements;
selecting one or more physical parameters for candidate pilot tests based at least in part on the model, the measurements, and the model confidence index;
designing pilot tests for the individual candidate pilot tests based at least in part on one or more pilot test objectives, the model, and the model confidence index; and
selecting one or more pilot tests from among the designed pilot tests; and
generating a pilot test implementation plan for the selected one or more pilot tests.
